(19) United States
(12) Patent Application Publication
(10) Pub. No.: US 2008/0260385 A1
(43) Pub. Date: Oct. 23, 2008

(54) Signal processing apparatus and method for gigabit passive optical network

(75) Inventor: Kohei Eguchi, Chiba (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/979,497

(22) Filed: Nov. 5, 2007

(30) Foreign Application Priority Data
Dec. 26, 2006 (JP) 2006-349340

(51) Int. Cl. H04J 4/00; H04J 14/00

(52) U.S. Cl. 398/75

(57) ABSTRACT

A signal processing apparatus for use in an optical line termination or optical network unit in a gigabit passive optical network encapsulates Ethernet signals, time-division multiplexed signals, and asynchronous transfer mode signals in the same way in a novel type of frame. The same input and output circuits can accordingly be used to support all three types of communication. A low-cost chip set including at least the input and output circuits of the apparatus can be combined with conversion circuits as necessary to provide a flexible answer to the needs of specific gigabit passive optical network systems.

### BACKGROUND OF THE INVENTION

1. Field of the Invention

The present invention relates to a signal processing apparatus, a signal processing method, and a signal frame structure for a gigabit passive optical network (GPON), more particularly to its transmission convergence structure.

2. Description of the Related Art

Known systems that provide access to networks such as the Internet through optical fibers include fiber-to-the-home, fiber-to-the-curb, fiber-to-the-node, fiber-to-the-premises, and other such systems, all of which may be conveniently denoted FTTx. A passive optical network (PON) is one type of network that can be used to implement these FTTx systems.

FIG. 1 shows the general structure of a PON. An optical line termination (OLT) unit is connected through a single optical fiber to a passive optical coupler called a splitter 702, which branches the optical signal from the OLT 701 onto a plurality of optical fibers 703, enabling the OLT to connect with a plurality of optical network units (ONU) 704-1 to 704-n. The OLT 701 is connected to an Internet protocol (IP) network 705 such as a local area IP network or the Internet, and the ONUs 704 are connected to respective communication terminals 706-1 to 706-n such as personal computers.

The wavelength of the downstream optical signals used on the PON in transmission to the ONUs differs from the wavelength of the upstream optical signals used on the PON in transmission to the OLT. Bidirectional communication can accordingly be performed on a single strand of optical fiber.

Downstream transmission from the OLT to the ONUs is point-to-multipoint. The OLT 701 sends downstream signal frames Fd addressed to individual ONUs, as indicated by the characters 2, 3, 1, . . . , n in the downstream frames Fd in the drawing, to all of the ONUs 704-1 to 704-n. Each of the ONUs 704-1 to 704-n extracts the frames addressed to it from the received data stream by a method such as decryption, and discards the other frames.

Upstream transmission from the ONUs 704-1 to 704-n to the OLT is point-to-point. Upstream frames Fu, numbered 1 to n in the drawing, are transmitted to the OLT 701 from the ONUs at timings assigned by the OLT. The timings are assigned so that the frames from different ONUs do not collide in the splitter 702. The timing assignments take into consideration the different round-trip (upstream and downstream) transmission delays between the OLT and the ONUs 704-1 to 704-n, which are due to different distances between the splitter 702 and the ONUs.

GPON, standardized as Recommendation G.984 of the Telecommunication Standardization Sector of the International Telecommunications Union (ITU-T), is one of several known varieties of PON. GPON is an optical access network system capable of carrying Ethernet, time-division multiplexing (TDM), and asynchronous transfer mode (ATM) communication. The Ethernet communication system is used in the Internet and in local area networks, TDM is used in existing telephone networks, and ATM is usable in all sorts of voice, data, and video communication media. Known documents that disclose GPONs include Japanese Patent Application Publication Nos. 2004-320745 and 2004-320746, and ‘Series G: Transmission System And Media, Digital System And Networks’, February 2004, International Telecommunications Union, compiled by ITU-T Study Group 15.

Ethernet, incidentally, is a registered trademark.

The methods by which the three types of communication systems (Ethernet, TDM, and ATM) are accommodated in a GPON will be described below, first for downstream communication, then for upstream communication.

FIG. 2 shows the conceptual structure of the conventional GPON communication frame standardized in ITU-T Recommendation G.984. The frame used in GPON downstream communication fits into a 125-microsecond time slot and is referred to as a GPON transmission convergence (GTC) frame. A GTC frame includes overhead and a payload.

The overhead section, which is necessary for communication control, maintenance, and operation, includes a frame header known as a downstream physical control block (PCBd) that gives a variety of information about the GTC frame. Part of the PCBd is an upstream bandwidth map that gives information for controlling upstream transmission by the ONUs 704-1 to 704-n. In the example in FIG. 2, a time slot consisting of bytes 100 to 300 is allotted to ONU 704-1, which has allocation identifier (ALLOC ID) ‘1’, a time slot consisting of bytes 400 to 500 is allotted to ONU 704-2 (ALLOC ID ‘2’), and a time slot consisting of bytes 520 to 600 is allotted to the ONU 704-3 (ALLOC ID ‘3’).

The payload section, which carries user's signals, includes an ATM partition and a GPON encapsulation mode (GEM) partition. The ATM partition carries unaltered ATM cells. The GEM partition accommodates a GEM frame. The GEM frame may include Ethernet or TDM signals as described below. The PCBd in the overhead gives information indicating the boundary between the ATM and GEM partitions.

In upstream transmission, each ONU sends a frame including overhead and a payload. If the upstream signal is an ATM signal, one or more ATM cells are directly mapped onto the payload as in the ATM partition in a downstream signal. If the upstream signal is an Ethernet signal or a TDM signal, the signal is mapped onto a GEM frame, and the GEM frame is mapped onto the payload.

The transmit and receive processing in the ONU is carried out in a series of layers referred to as a protocol stack. FIG. 3 shows the conceptual structure of the conventional GTC frame layer in the protocol stack. There is a similar protocol stack in the OLT, but only the ONU protocol stack will be described here.

A downstream GTC frame is received by a GTC framing sublayer 910 of the GTC frame layer in each of the ONUs 704-1 to 704-n. In the GTC framing sublayer 910, an ATM signal is read from the ATM partition in the GTC frame or a GEM frame is read from the GEM partition, according to the ONU's allocation identifier, and the ATM signal or GEM frame is passed to a transmission convergence (TC) adaptation sublayer 920. When the GTC framing sublayer 910 reads an ATM signal, it is received by an ATM TC adapter 922 in the TC adaptation sublayer 920, and a VPI/VCI filter 925 identifies the logical path of the signal from the virtual path identifier (VPI) and virtual channel identifier (VCI) given as connection information in each cell, before outputting the signal to an ATM client that provides ATM service to the subscriber. When the GTC framing sublayer 910 reads a GEM signal, it is received by a GEM TC adapter 921 in the TC adaptation sublayer 920, and a port-ID and PTI filter 923 identifies its logical path from the port identification (ID) value and payload type indicator (PTI) code given as connection information in the signal, before outputting the signal to a GEM client, which may provide either Ethernet service or TDM service.

In upstream transmission, the GTC framing sublayer 910 in each of the ONUs 704-1 to 704-n generates a container corresponding to the ONU's allocation identifier, maps the ATM signal or the GEM frame onto the payload of the container, and transmits the container (see FIG. 2). The containers sent from the ONUs 704-1 to 704-n are passively multiplexed in the splitter 702 and sent to the OLT 701 (see FIG. 1).

FIG. 4 shows the general structure of a conventional GPON signal processing apparatus. This is one example of an ONU signal processing apparatus that realizes the GTC frame layer of the protocol stack described above. The apparatus is depicted as a collection of functions and interfaces, which are implemented by a combination of hardware and software in one or more integrated circuits.

In downstream transmission, the GTC deframing function 1050, GEM extraction function 1052, and ATM extraction function 1053 in FIG. 4 correspond to the multiplexer 911, GEM partition 913, and ATM partition 914, respectively, in the GTC framing sublayer 910 in FIG. 3.

The distribution function 1054, GEM-to-Ethernet conversion function 1062, and GEM-to-TDM conversion function 1064 correspond to the port-ID and PTI filter 923 in the TC adaptation sublayer 920, the conversion functions forming a GEM interface (IF). The ATM interface 1076 corresponds to the VPI/VCI filter 925. Although no blocks are shown N corresponding to the GEM TC adapter 921 and ATM TC adapter 922 in FIG. 3, the functions of these adapters are realized when GEM frames are passed from the GEM extraction function 1052 to the distribution function 1054, and ATM signals are passed from ATM extraction function 1053 to the ATM interface 1076 in FIG. 4.

In upstream transmission, the GTC framing function 1034, GEM mapping function 1032, and ATM mapping function 1033 in FIG. 4 correspond to the multiplexer 911, GEM partition 913, and ATM partition 914, respectively, in the GTC framing sublayer 910 in FIG. 3. The Ethernet-to-GEM conversion function 1012 and TDM-to-GEM conversion function 1014 correspond to the port-ID and PTI filter 923 in the TC adaptation sublayer 920. Although no blocks corresponding to the ATM TC adapter 922 and VPI/VCI filter 925 in FIG. 3 are shown, the corresponding functions are realized when ATM signals are passed from the ATM interface 1006 to the bandwidth management buffer function (for ATM) 1031. Similarly, although no block corresponding to the GEM TC adapter 921 is shown, the corresponding function is realized when GEM frames are passed from the Ethernet-to-GEM conversion function 1012 and TDM-to-GEM conversion function 1014 to the bandwidth management buffer function (for GEM) 1030.

The conventional apparatus in FIG. 4 also includes a pair of Ethernet interfaces 1002, 1072, a pair of TDM interfaces 1004, 1074, a port-ID manager 1020, and a mapping information extraction function 1040. The mapping information extraction function 1040 passes bandwidth allocation information from the GTC deframing function 1050 to the GEM mapping function 1032, the ATM mapping function 1033, and the GTC framing function 1034, to enable the upstream GTC frames to be transmitted at the proper timings.

FIG. 5 shows the conceptual structure of a GEM frame. The GEM frame includes five bytes (40 bits) of overhead and a payload consisting of an arbitrary number of bytes. The overhead includes a 12-bit payload length indicator (PLI), a 12-bit port identifier (ID), a 3-bit PTI code, and a 13-bit header error control (HEC) section. The meaning of the PTI code is defined in ITU-T Recommendation G.984 as shown in FIG. 6.

In ITU-T Recommendation G.984, a GEM frame accommodates Ethernet and TDM signals as described above. A single Ethernet or TDM signaling unit (e.g., an Ethernet packet) may be mapped onto a single GEM frame, or may be divided among a plurality of GEM frames. A single Ethernet or TDM signaling unit is mapped onto a single GEM frame in the example shown in FIG. 7, onto two GEM frames in the example shown in FIG. 8, and onto three GEM frames in the example shown in FIG. 9. In the overhead of the last GEM frame (or a single GEM frame), ‘001’ is set in the PTI field; in the overhead of the other GEM frames, ‘000’ is set in the PTI field. Furthermore, when a single Ethernet signal or TDM signal is mapped onto a plurality of GEM frames, the GEM frames may be mapped onto a plurality of GTC frames. The payload of a GTC frame is thereby used efficiently, and transmission efficiency can be increased by inserting urgent frames into spaces between fragments of non-urgent frames. In FIG. 10, for example, one fragment (FRAG) of a first GEM frame (GEM1a) and an entire second GEM frame (GEM2) are mapped onto a first GTC frame (GTC1), and another fragment of the first GEM frame (GEM1b) and an entire third GEM frame (GEM3) are mapped onto a second GTC frame (GTC2). In FIG. 10, upstream physical layer overhead (PLOu) is placed in an overhead section that includes the preamble of the GTC frame.

FIG. 11 shows how Ethernet signals are mapped onto GEM frames. Ethernet signals are made up of packets. An Ethernet packet includes an inter-packet gap (IPG), which is a signal equivalent to the delay between the preceding packet transmission and the present packet transmission, a preamble and a start frame delimiter (SFD), which are signals for indicating the start of frame transmission, a destination address (DA), a source address (SA), length/type information indicating the length of the data field or the type of upper layer protocol, the data field, a frame check sequence (FCS) for detecting errors, and an end of frame (EOF) code that indicates the end of the Ethernet packet. The data field is labeled MAC client in the drawing because the data are processed in the MAC (media access control) client layer of the protocol stack. In GPON, the DA, SA, length/type, MAC client, and FCS fields of the Ethernet packet are mapped onto the payload of a GEM frame.

FIG. 12 shows how TDM signals are mapped onto a GEM frame. The unaltered TDM signal is placed in the payload of the GEM frame.

As described above, ITU-T Recommendation G.984 maps the unaltered ATM cells of an ATM signal onto an ATM partition of a GTC frame, and maps Ethernet and TDM signals onto a GEM partition (see FIG. 2). A VPI and VCI are used for processing ATM signals, while a port identifier (ID) value and PTI code are used for processing Ethernet and TDM signals (see FIG. 3). An OLT or ONU conforming to ITU-T Recommendation G.984 accordingly needs separate functions for processing ATM signals and GEM frames (Ethernet signals and TDM signals), increasing the cost of the OLT and ONU components of the GPON.

ATM communication service is currently provided in fewer countries and territories than Ethernet and TDM communication service. Furthermore, since ATM communication service is not heavily used, when GPONs are constructed, many of them may not support ATM communication. Accordingly, there is a need for a method of processing ATM signals at a low cost.

### SUMMARY OF THE INVENTION

An object of the present invention is to provide a simple, low cost ATM-capable signal processing apparatus for use in GPON equipment such as an OLT or ONU.

Another object of the invention is to provide a signal processing method and a GTC frame for use in the invented signal processing apparatus.

The invented signal processing apparatus comprises an Ethernet-to-GEM conversion function, a TDM-to-GEM conversion function, a non-GEM-to-GEM conversion function, a GEM-to-Ethernet conversion function, a GEM-to-TDM conversion function, a GEM-to-non-GEM conversion function, a GTC input section, a GTC output section, and a mapping information management function.

The Ethernet-to-GEM conversion function converts an input Ethernet signal to a GEM frame. The TDM-to-GEM conversion function converts an input TDM signal to a GEM frame. The non-GEM-to-GEM conversion function converts a non-GEM signal to a GEM frame.

The GTC output section assigns GEM frames generated by the Ethernet-to-GEM conversion function, the TDM-to-GEM conversion function, and the non-GEM-to-GEM conversion function to output time slots, based on mapping information generated by the mapping information management function, adds overhead to the assigned GEM frames to create GTC frames, and outputs the GTC frames.

The GTC input section extracts GEM frames from received GTC frames, determines which one of an Ethernet signal, a TDM signal, and a non-GEM signal is included in each GEM frame, and sends GEM frames including Ethernet signals to the GEM-to-Ethernet conversion function, GEM frames including TDM signals to the GEM-to-TDM conversion function, and GEM frames including non-GEM signals to the GEM-to-non-GEM conversion function.

The GEM-to-Ethernet conversion function converts GEM frames to Ethernet signals. The GEM-to-TDM conversion function converts GEM frames to TDM signals. The GEM-to-non-GEM conversion function converts GEM frames to non-GEM signals.

A non-GEM signal is a signal, such as an ATM signal, that is not placed in a GEM frame under the conventional GPON practice. A TDM signal with a different bandwidth from the TDM signals input to the TDM-to-GEM conversion function and output from the GEM-to-TDM conversion function may also be treated as a non-GEM signal.

The mapping information management function generates mapping information from the overhead of the GTC frame input to the GTC input section and sends the mapping information to the GTC output section.

In a preferred embodiment of the above signal processing apparatus, the GTC input section includes a GTC deframing function, a GEM extraction function, and a distribution function, and the GTC output section includes a bandwidth management buffer function, a GEM mapping function, and a GTC framing function.

The GTC deframing function disassembles input GTC frame into overhead and a payload, and sends the overhead to the mapping information management function and the payload to the GEM extraction function. The GEM extraction function extracts a GEM frame from the payload and sends the GEM frame to the distribution function.

The distribution function determines which one of an Ethernet signal, a TDM signal, and a non-GEM signal is included in the GEM frame, and sends the GEM frame to the GEM-to-Ethernet conversion function if it includes an Ethernet signal, to the GEM-to-TDM conversion function if it includes a TDM signal, and to the GEM-to-non-GEM conversion function if it includes a non-GEM signal.

The bandwidth management buffer function stores GEM frames received from the Ethernet-to-GEM conversion function, the TDM-to-GEM conversion function, and the non-GEM-to-GEM conversion function temporarily in a buffer, awaiting output, and sends the GEM frames to the GEM mapping function responsive to commands from the GEM mapping function.

The GEM mapping function assigns the GEM frames received from the bandwidth management buffer function to the output time slots of GTC frames according to the mapping information received from the mapping information management function.

The GTC framing function generates a frame header, attaches the frame header as overhead to one or more GEM frames or fragments thereof to generate a GTC frame, and outputs the GTC frame in the time slot to which the GEM frame or frames in its payload were assigned.

In a preferred embodiment, the GTC input section, GTC output section, mapping information management function, Ethernet-to-GEM conversion function, GEM-to-Ethernet conversion function, TDM-to-GEM conversion function, and GEM-to-TDM conversion function are implemented in a chip set, and the non-GEM-to-GEM conversion function and GEM-to-non-GEM conversion function are implemented outside the chip set.

Alternatively, the GTC input section, GTC output section, and mapping information management function may be implemented in a chip set, and the Ethernet-to-GEM, GEM-to-Ethernet, TDM-to-GEM, GEM-to-TDM, non-GEM-to-GEM, and GEM-to-non-GEM conversion functions may be implemented outside the chip set.

The invention provides a signal processing method for use in generating GTC frames. First, in a conversion step, an input Ethernet signal TDM signal, or non-GEM signal is converted to a GEM frame. Next, in a mapping step, the GEM frame is assigned to a time slot, or is divided into fragments which are assigned to different time slots. Next, in a GTC framing step, overhead is generated for the GEM frames and/or fragments assigned to each time slot, and these GEM frames and/or fragments are output together with the overhead as a GTC frame in the assigned time slot.

The invention also provides a signal processing method for use in receiving GTC frames. First, in a GTC deframing step, a GTC frame is input and disassembled into overhead and a payload. A GEM frame is then extracted from the payload. Whether the GEM frame includes an Ethernet signal, a TDM signal, or a non-GEM signal is determined, and the GEM frame is converted to an Ethernet signal, a TDM signal, or a non-GEM signal, accordingly.

The GTC frame provided by the present invention for use in a gigabit passive optical network comprises an overhead section accommodating information necessary for control, maintenance, and operation, and a payload accommodating user signals. The payload one or more GEM frames, or fragments thereof. A GEM frame may encapsulate an Ethernet signal, a TDM signal, or a non-GEM signal.

In the novel signal processing apparatus and method and GTC frame, Ethernet, TDM, and ATM signals or other non-GEM signals are all converted to GEM frames, thereby providing a more unified form of signal processing than in conventional GPON systems, which convert only Ethernet and TDM signals to GEM frames and do not convert ATM signals to GEM frames.

Consequently, the invented signal processing apparatus does not require a separate bandwidth management buffer function for ATM, a separate ATM mapping function, and a separate ATM extraction function, and has a correspondingly simpler circuit configuration.

If the GTC input section, GTC output section, mapping information management function, Ethernet-to-GEM conversion function, GEM-to-Ethernet conversion function, TDM-to-GEM conversion function, and GEM-to-TDM conversion function are implemented in a chip set, and the non-GEM-to-GEM conversion function and GEM-to-non-GEM conversion function are implemented outside the chip set, then the chip set can be used in signal processing apparatus that does not support ATM service without burdening the apparatus with unnecessary ATM signal-processing circuitry. In this case, the non-GEM-to-GEM and GEM-to-non-GEM conversion functions can be used to process time-division multiplexed signals having a different bandwidth (bit rate) from the TDM signals processed by the TDM interfaces in the chip set.

Alternatively, the chip set may include only the GTC input and output sections and the mapping information management function, forming a core that is independent of the types of communication service being supported. The low-cost core chip set can then be used in all GPON systems, and can be supplemented with only the necessary additional chips in each system in which it is used, where the additional chips provide the Ethernet-to-GEM conversion function, GEM-to-Ethernet conversion function, TDM-to-GEM conversion function, GEM-to-TDM conversion function, non-GEM-to-GEM conversion function, and GEM-to-non-GEM conversion function as necessary.

### BRIEF DESCRIPTION OF THE DRAWINGS

In the attached drawings:

FIG. 1 is a schematic drawing of a PON;

FIG. 2 is a conceptual diagram illustrating the configuration of a conventional GPON communication frame;

FIG. 3 is a schematic drawing of a conventional GTC frame and the corresponding layer in the protocol stack;

FIG. 4 is a schematic block diagram of an exemplary conventional GPON signal processing apparatus;

FIG. 5 illustrates a GEM frame;

FIG. 6 explains the PTI code in FIG. 5;

FIG. 7 to 10 are conceptual diagrams showing how GEM frames are mapped onto GTE frames;

FIG. 11 is a conceptual diagram showing how Ethernet signals are mapped onto a GEM frame;

FIG. 12 is a conceptual diagram showing how TDM signals are mapped onto a GEM frame;

FIG. 13 is a conceptual block diagram illustrating the configuration of a novel ONU signal processing apparatus in a GPON system;

FIG. 14 is a conceptual diagram showing how the novel apparatus encapsulates an ATM cell in a GEM frame;

FIG. 15 is a conceptual diagram illustrating a novel configuration of the GTC frame layer configuration in the GPON protocol stack;

FIG. 16 is a schematic diagram illustrating the configuration of a novel OLT signal processing apparatus in a GPON system;

FIG. 17 is a schematic diagram illustrating the configuration of another novel signal processing apparatus; and

FIG. 18 is a schematic diagram illustrating the configuration of another novel signal processing apparatus.

### DETAILED DESCRIPTION OF THE INVENTION

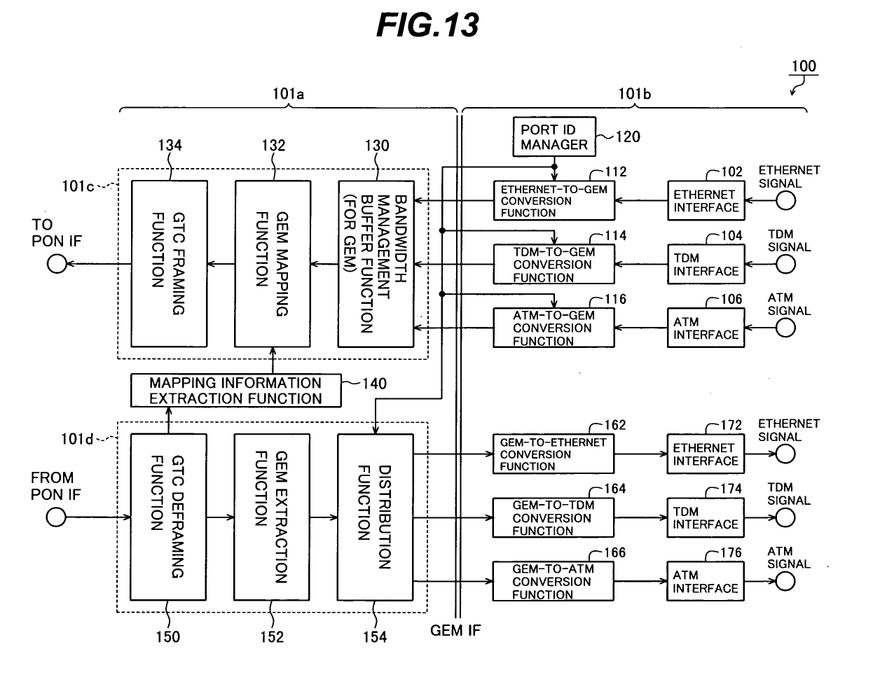

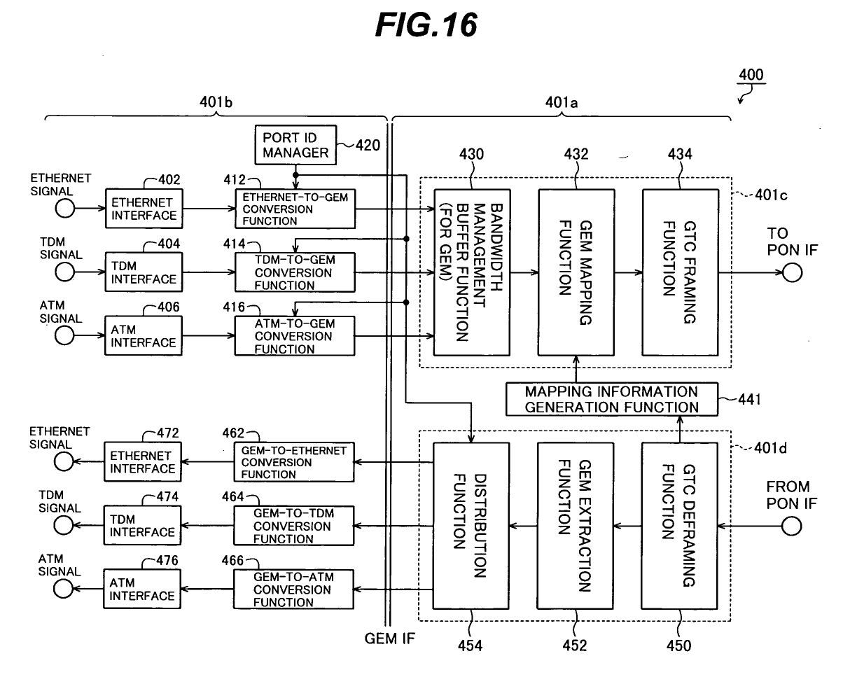

An embodiment of the invention will now be described with reference to the attached drawings, in which like elements are indicated by analogous reference characters. When the same function appears in different apparatus, reference characters with three numeric digits will be used, the last two numeric digits identifying the function, the first numeric digit identifying the apparatus. For example, the bandwidth management buffer function 130 in the signal processing apparatus 100 in FIG. 13 performs the same operations as the bandwidth management buffer function 430 in the signal processing apparatus 400 in FIG. 16.

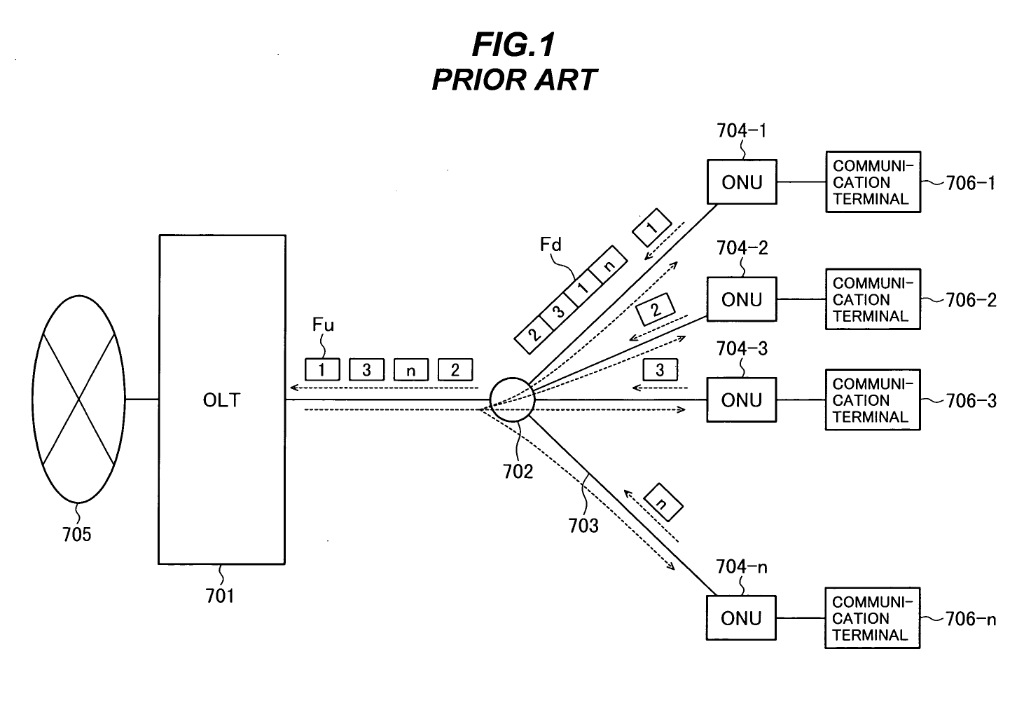

The description will refer back to FIG. 1, using the notation ONU 704 to refer to a general one of the ONUs 704-1 to 704-2, . . . and communication terminal 706 to refer to the one of the communication terminals 706-1 to 706-n to which the ONU 704 is connected.

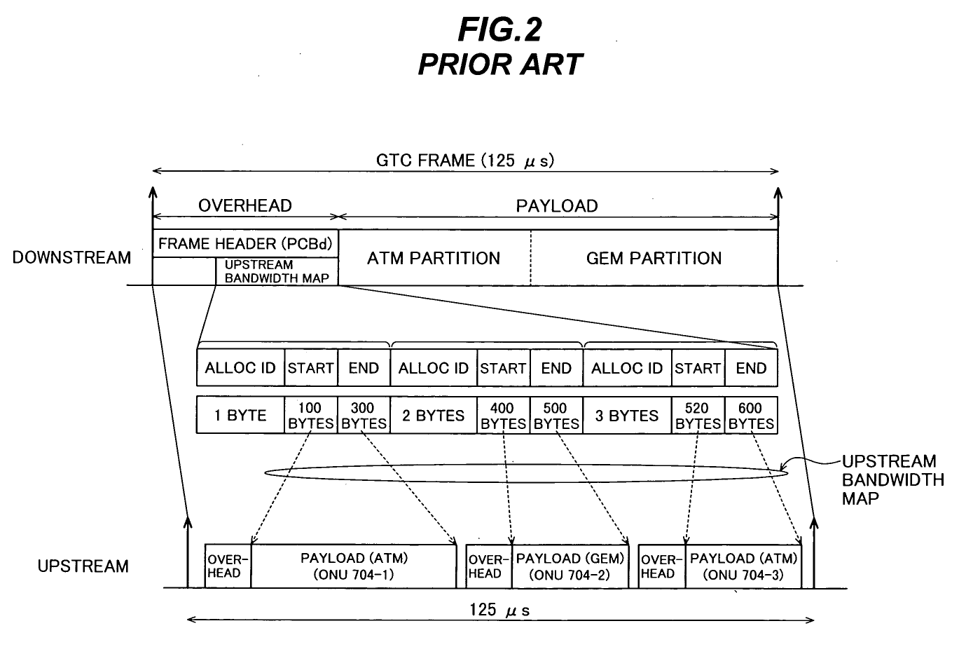

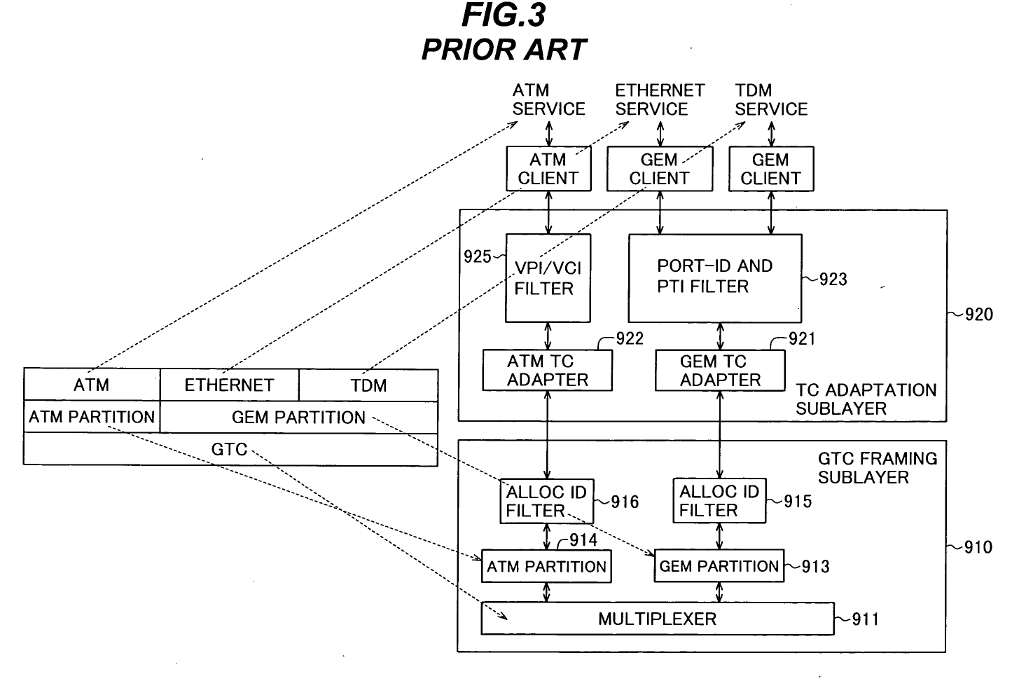

FIG. 13 shows the general structure of a novel signal processing apparatus for an ONU in a GPON. An ATM signal will be used as an example of a non-GEM signal which was not mapped onto a GEM frame in the conventional GTC frame described with reference to FIG. 2.

The signal processing apparatus 100 in FIG. 13 processes electrical signals. The ONU also includes a PON interface (PON IF, not shown) that converts the electrical signals to optical signals for transmission on the PON, and converts optical signals received from the PON to electrical signals.

The signal processing apparatus 100 in FIG. 13 comprises a core section 101a having a structure independent of the types of communication service supported and a service section 101b having a structure that depends on these types. The service section 101b includes an Ethernet-to-GEM conversion function 112, a TDM-to-GEM conversion function 114, an ATM-to-GEM conversion function 116, a GEM-to-Ethernet conversion function 162, a GEM-to-TDM conversion function 164, a GEM-to-ATM conversion function 166, and a port-ID manager 120. The core section 101a includes a GTC output section 101c having a bandwidth management buffer function 130, a GEM mapping function 132, and a GTC framing function 134, a GTC input section 101d having a GTC deframing function 150, a GEM extraction function 152, and a distribution function 154, and a mapping information extraction function 140.

The signal processing apparatus 100 also comprises an Ethernet interface 102 for output of Ethernet signals, a TDM interface 104 for output of TDM signals, an ATM interface 106 for output of ATM signals, an Ethernet interface 172 for input of Ethernet signals, a TDM interface 174 for input of TDM signals, and an ATM interface 176 for input of ATM signals.

The signal processing apparatus 100 may be used in any of the ONUs 704 in FIG. 1, and may receive Ethernet, TDM, and/or ATM signals from the corresponding subscriber's communication terminal 706.

Ethernet interface 102 converts a received Ethernet signal to a format internal to the ONU, and sends the converted Ethernet signal to the Ethernet-to-GEM conversion function 112. The Ethernet-to-GEM conversion function 112 converts the converted Ethernet signal to a GEM frame. In this process, the Ethernet-to-GEM conversion function 112 receives the port identifier (ID) necessary for generation of the GEM frame from the port-ID manager 120, and uses the port ID to generate the GEM frame.

TDM interface 104 converts a received TDM signal to a format internal to the ONU, and sends the converted TDM signal to the TDM-to-GEM conversion function 114. The TDM-to-GEM conversion function 114 converts the converted TDM signal to a GEM frame. In this process, the Ethernet-to-GEM conversion function 112 receives the port identifier (ID) necessary for generation of the GEM frame from the port-ID manager 120, and uses the port ID to generate the GEM frame.

The ATM interface 106 converts a received ATM signal to a format internal to the ONU, and sends the converted ATM signal to the ATM-to-GEM conversion function 116. The ATM-to-GEM conversion function 116 converts the converted ATM signal to a GEM frame. In this process, the Ethernet-to-GEM conversion function 112 receives the port identifier (ID) necessary for generation of the GEM frame from the port-ID manager 120, and uses the port ID to generate the GEM frame.

In each case, the generated GEM frame is sent to the bandwidth management buffer function 130, where it waits in a predetermined buffer being until to the OLT 701.

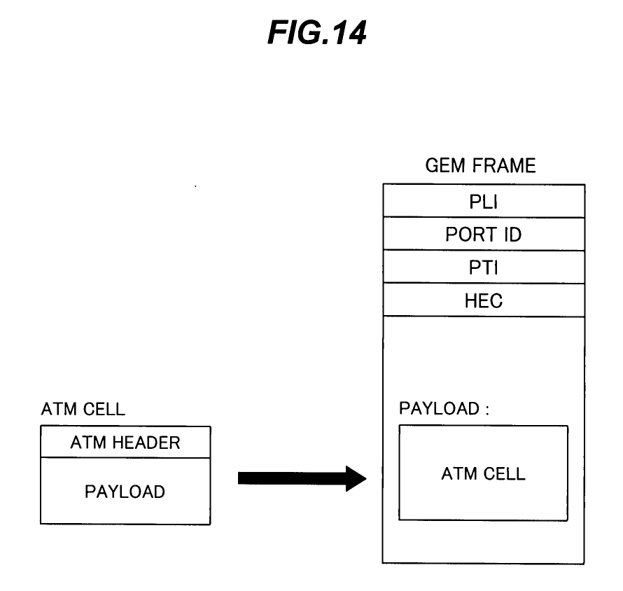

In signal processing apparatus according to the present invention, ATM signals as well as Ethernet and TDM signals are mapped onto GEM frames. An ATM signal may be mapped onto a GEM frame, that is, encapsulated in a GEM frame, by any preferred method. FIG. 14 shows an example in which a single ATM cell is mapped onto a GEM frame by encapsulating the ATM cell without alteration in the payload of the GEM frame. A plurality of entire ATM cells may be encapsulated in this way the payload of a single GEM frame.

The bandwidth management buffer function 130 sends each GEM frame awaiting output in the predetermined buffer to the GEM mapping function 132 responsive to a command from the GEM mapping function 132.

The GEM mapping function 132 sends the command to the bandwidth management buffer function 130 according to mapping information received from the mapping information extraction function 140, which operates as the mapping information management function, and assigns the GEM frame to an appropriate output time slot for output in a GTC frame. The upstream transmission timings of GTC frames are determined according to the mapping information so as to multiplex the transmissions of different ONUs. The functions of the mapping information extraction function 140 will be described in more detail below.

The GTC framing function 134 generates GTC frames. More specifically, the GTC framing function 134 maps each GEM frame assigned to an output time slot onto the payload of a GTC frame, generates a frame header for the GTC frame, and places the header in the overhead part of the frame.

In upstream transmission, a GTC frame generated in the GTC framing function 134 is converted to an optical signal in the PON interface (not shown) of the ONU, and sent to the OLT.

In downstream transmission, the ONU receives a GTC frame from the OLT. The GTC frame is converted from an optical signal to an electrical signal in the PON interface (not shown) and sent to the GTC deframing function 150.

The GTC deframing function 150 disassembles the GTC frame into overhead and a payload. The GTC deframing function 150 sends the payload of the GTC frame to the GEM extraction function 152, and the overhead to the mapping information extraction function 140.

The mapping information extraction function 140 (the mapping information management function) generates GEM mapping information by extracting an upstream bandwidth map, added by the OLT 701 (FIG. 1), from the overhead of the GTC frame. The GEM mapping information is sent to the GEM mapping function 132, where it is used to determine the upstream transmission timing, so that upstream signals from different ONUs can be multiplexed in the splitter 702 without colliding.

The GEM extraction function 152 extracts a GEM frame from the payload of the GTC frame. The extracted GEM frame is sent to the distribution function 154.

The distribution function 154 determines which one of an Ethernet signal, a TDM signal, and an ATM signal is included in the GEM frame, according to the port ID information received from the port-ID manager 120. The distribution function 154 sends a GEM frame including an Ethernet signal to the GEM-to-Ethernet conversion function 162, a GEM frame including a TDM signal to the GEM-to-TDM conversion function 164, and a GEM frame including an ATM signal to the GEM-to-ATM conversion function 166.

Upon receiving a GEM frame, the GEM-to-Ethernet conversion function 162 converts the GEM frame to an Ethernet signal, and sends the Ethernet signal to the Ethernet interface 172. The Ethernet interface 172 converts the Ethernet signal, which is formatted in the internal ONU format, to an appropriate Ethernet signal format, and outputs the converted Ethernet signal to the subscriber's communication terminal 706.

Similarly, upon receiving a GEM frame, the GEM-to-TDM conversion function 164 converts the GEM frame to a TDM signal, and sends the TDM signal to the TDM interface 174. The TDM interface 174 converts the TDM signal, which is in the internal ONU format, to an appropriate TDM signal format, and outputs the converted TDM signal to the communication terminal 706.

The GEM-to-ATM conversion function 166, when it receives a GEM frame, converts the received GEM frame to an ATM signal, and sends the ATM signal to the ATM interface 176. The ATM interface 176 converts the ATM signal, which is also in the internal ONU format, to an appropriate ATM signal format, and outputs the converted ATM signal to the communication terminal 706.

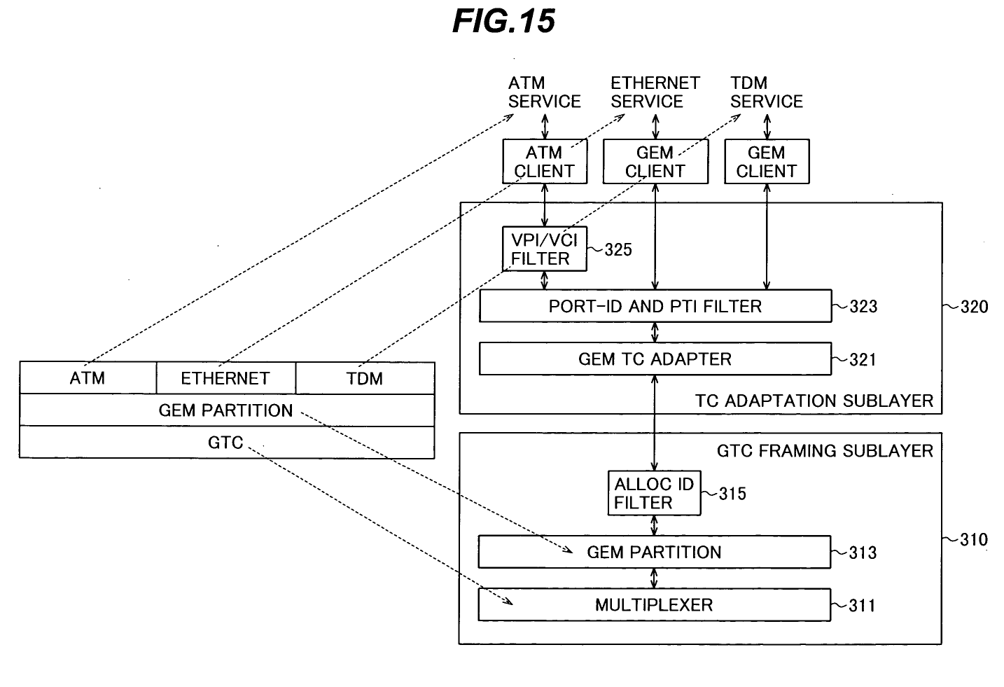

FIG. 15 shows the conceptual structure of the novel GTC frame and the novel GTC frame layer in the protocol stack.

The novel GTC frame includes an overhead section (not shown), which includes information necessary for communication control, maintenance, and operation, and a payload section, which accommodates user signals. A detailed description of the overhead section of the novel GTC frame will be omitted, since it is the same as in the conventional GTC frame described with reference to FIG. 2.

The payload section includes only a GEM partition, which accommodates one or more GEM frames or fragments thereof. Each GEM frame includes only one type of signal: an Ethernet signal, a TDM signal, or a non-GEM signal.

The difference between the GTC frame used in the present invention and the conventional GTC frame is that the payload section is not divided into an ATM partition and a GEM partition. The entire payload section is treated as a GEM partition; there is no ATM partition. The ATM cells that were mapped onto the ATM partition in a conventional GTC frame are mapped onto the GEM frame partition in the novel GTC frame. More precisely, ATM signals, like TDM and Ethernet signals, are encapsulated in GEM frames, which are mapped onto the GEM partition of the GTC frame (see FIG. 15).

In the downstream direction, the novel GTC frame has the conventional physical control block, specifying the start and end of each ONU's bandwidth allocation. The overhead section of the frame complies with ITU-T Recommendation G.984, so the frame can be transported on a GPON complying with ITU-T Recommendation G.984.

Downstream GTC frames are received by a GTC framing sublayer 310 in the ONU, and GEM frames read from the payloads of according to the ONU's bandwidth allocation, which is identified in the frame overhead. The GTC deframing function 150 and GEM extraction function 152 in FIG. 13 correspond to the multiplexer 311 and GEM partition 313, respectively, in the GTC framing sublayer 310 in FIG. 15.

When the GTC framing sublayer 310 reads a GEM frame, it is received by a GEM TC adapter 321 in the TC adaptation sublayer 320, and a port-ID and PTI filter 323 identifies its logical path from the port ID value and PTI code. If the GEM frame includes an Ethernet or TDM signal and is destined to a GEM client, the port-ID and PTI filter 323 sends the frame signal to the GEM client.

When the GEM frame includes an ATM signal, the port-ID and PTI filter 323 sends the signal to a VPI/VCI filter 325. The VPI/VCI filter 325 identifies the logical path of the signal from the VPI and VCI in the ATM header information encapsulated in the frame, and sends the signal to an ATM client.

The distribution function 154, GEM-to-Ethernet conversion function 162, GEM-to-TDM conversion function 164, and GEM-to-ATM conversion function 166 in FIG. 13 correspond to the port-ID and PTI filter 323 in the TC adaptation sublayer 320 in FIG. 15. The GEM-to-ATM conversion function 166 corresponds to the VPI/VCI filter 325.

Although no block in FIG. 13 corresponds directly to the GEM TC adapter 321 in FIG. 15, the adapter function is carried out when GEM frames are passed from the GEM extraction function 152 to the distribution function 154. Other processing is also performed, such as identifying the logical path of an Ethernet signal from its medium access control (MAC) address, for example, but a description will be omitted as this processing is well known.

In upstream transmission, the GTC framing function 134, GEM mapping function 132, and bandwidth management buffer function 130 in FIG. 13 correspond to the multiplexer 311, GEM partition 313, and allocation ID filter 315, respectively, in the GTC framing sublayer 310 in FIG. 15. The Ethernet-to-GEM conversion function 112, TDM-to-GEM conversion function 114, and ATM-to-GEM conversion function 116 correspond to the port-ID and PTI filter 323 in the TC adaptation sublayer 320.

Although there is no block in FIG. 13 corresponding directly to the VPI/VCI filter 325 in FIG. 15, the corresponding filter function is carried out when ATM signals are passed from the ATM interface 106 to the ATM-to-GEM conversion function 116. Similarly, although no block in FIG. 13 corresponds directly to the GEM TC adapter 321 in FIG. 15, the adapter function is carried out when GEM frames are passed from the GEM extraction function 152 to the distribution function 154.

FIG. 16 shows the general structure of a novel signal processing apparatus for use in an OLT in a GPON. The OLT also includes a PON interface (PON IF, not shown) for conversion between electrical and optical signals.

The OLT receives Ethernet, TDM, and ATM signals from, for example, an IP based network.

The OLT comprises an Ethernet interface 402, a TDM interface 404, and an ATM interface 406. The Ethernet interface 402 converts a received Ethernet signal to a format internal to the OLT, and sends the converted Ethernet signal to an Ethernet-to-GEM conversion function 412. The TDM interface 404 converts a received TDM signal to the internal OLT format, and sends the converted TDM signal to a TDM-to-GEM conversion function 414. The ATM interface 406 converts a received ATM signal to the internal OLT format, and sends the converted ATM signal to an ATM-to-GEM conversion function 416.

The Ethernet-to-GEM conversion function 412, TDM-to-GEM conversion function 414, ATM-to-GEM conversion function 416, a port-ID manager 420, bandwidth management buffer function 430, GEM mapping function 432, and GTC framing function 434 cooperate to generate GTC frames from the Ethernet, TDM, and ATM signals in the same way as the corresponding ONU elements in FIG. 13. A detailed description will be omitted.

In downstream transmission, GTC frames generated in the GTC framing function 434 are output from the PON interface in the OLT to the ONUs.

In upstream transmission, the OLT receives GTC frames as optical signals from the connected ONUs. The PON interface in the OLT converts the GTC frames to electrical signals and sends them to the GTC deframing function 450.

The GTC deframing function 450, GEM extraction function 452, distribution function 454, GEM-to-Ethernet conversion function 462, GEM-to-TDM conversion function 464, GEM-to-ATM conversion function 466, Ethernet interface 472, TDM interface 474, and ATM interface 476 in the OLT in FIG. 16 generate Ethernet, TDM, and ATM signals from GTC frames in the same way as the corresponding elements in the ONU in FIG. 13. A detailed description will be omitted.

A mapping information generation function 441, which controls mapping and multiplexing, generates upstream GEM mapping information by calculating bandwidth allocations from the bandwidth control information in the overhead of the GTC frames received from the ONUs. The mapping information generation function 441 sends the generated GEM mapping information to the GEM mapping function 432, thereby operating as the mapping information management function.

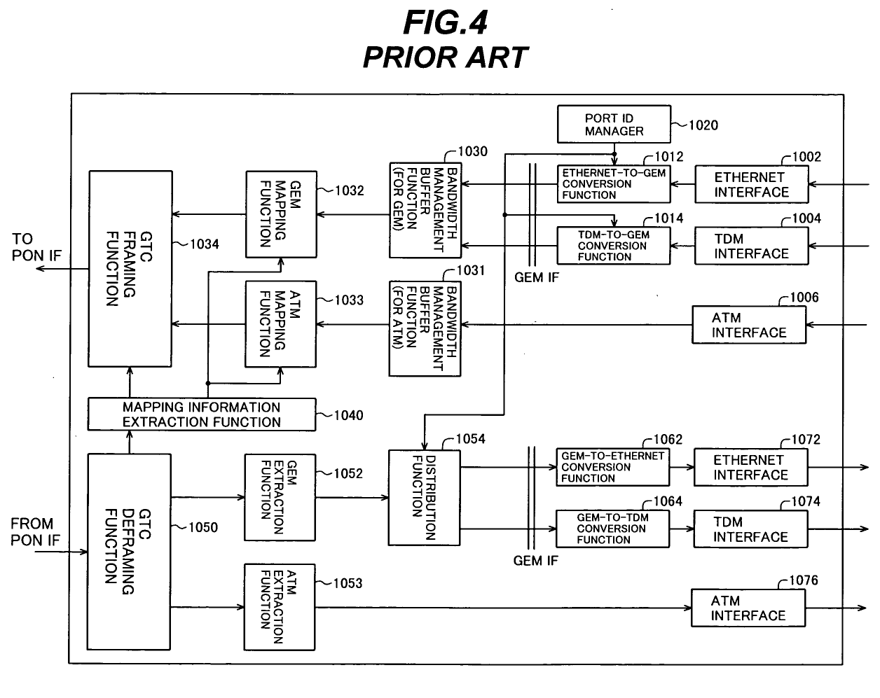

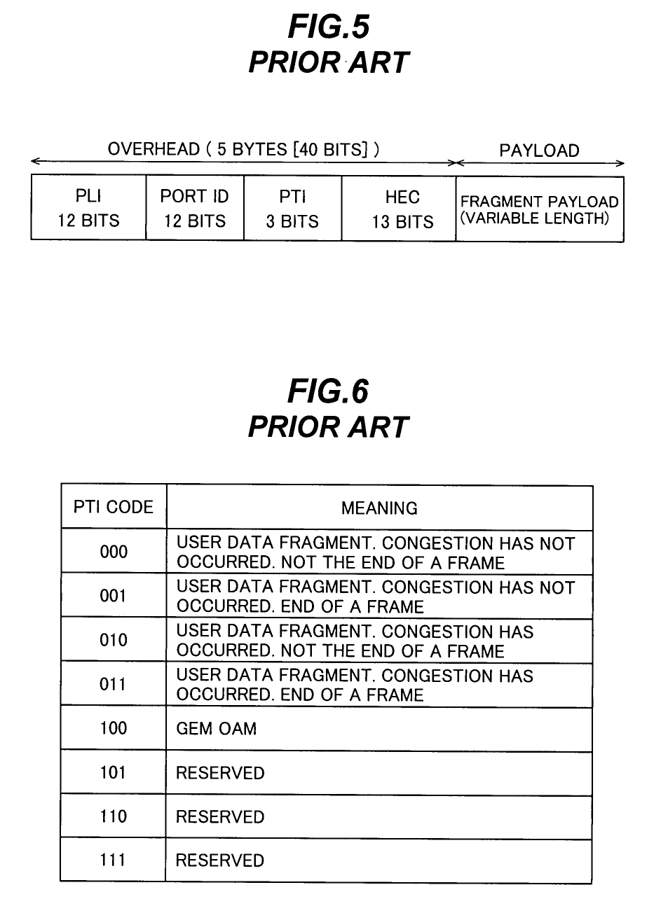

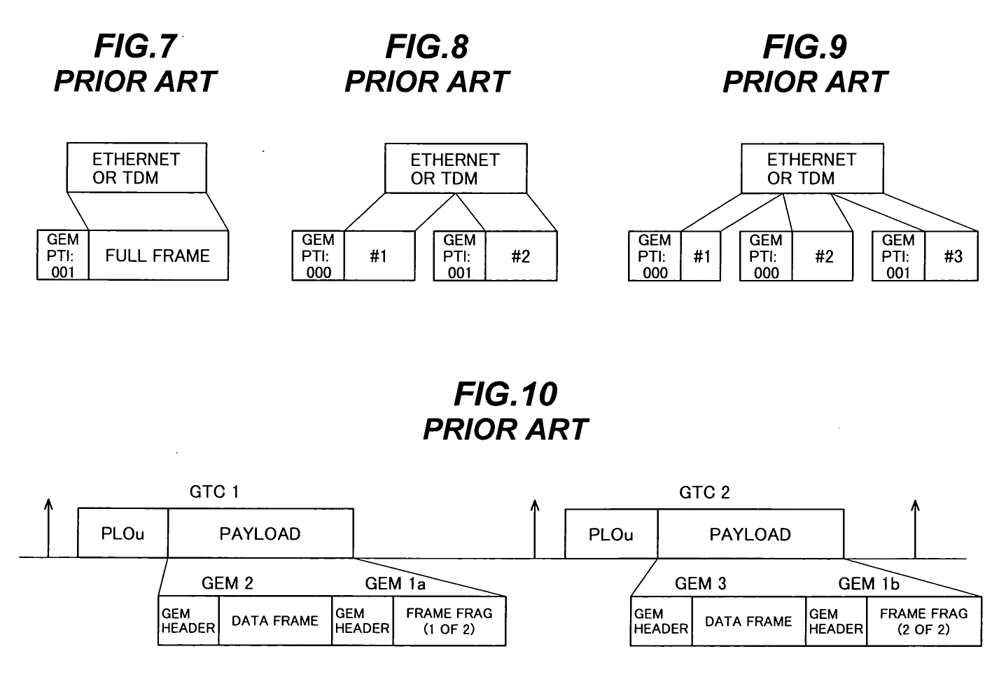

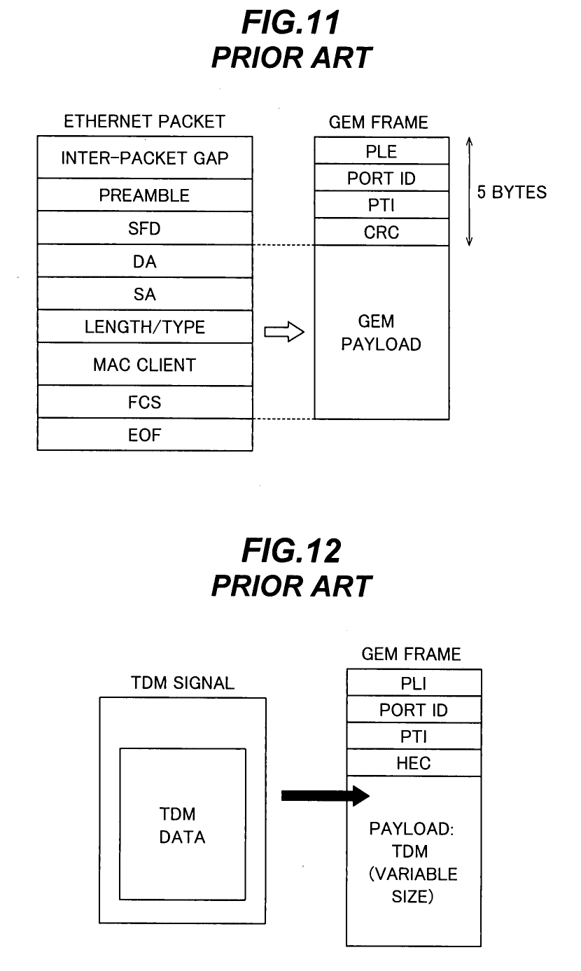

The ONU and OLT signal processing apparatus described above converts Ethernet signals, TDM signals, and ATM signals to GEM frames for use in GPON systems, thereby providing a more unified form of signal processing than in conventional GPON systems. As the signal processing apparatus does not require a separate bandwidth management buffer function for ATM, a separate ATM mapping function, and a separate ATM extraction function, it has a simpler configuration than the conventional apparatus in FIG. 4.

The novel signal processing apparatus may be implemented as a chip set, that is, a set of two or more monolithic integrated circuits designed to operate together. Such a chip set may include all of the functional elements shown in FIG. 13 or 16, but this is not necessary.

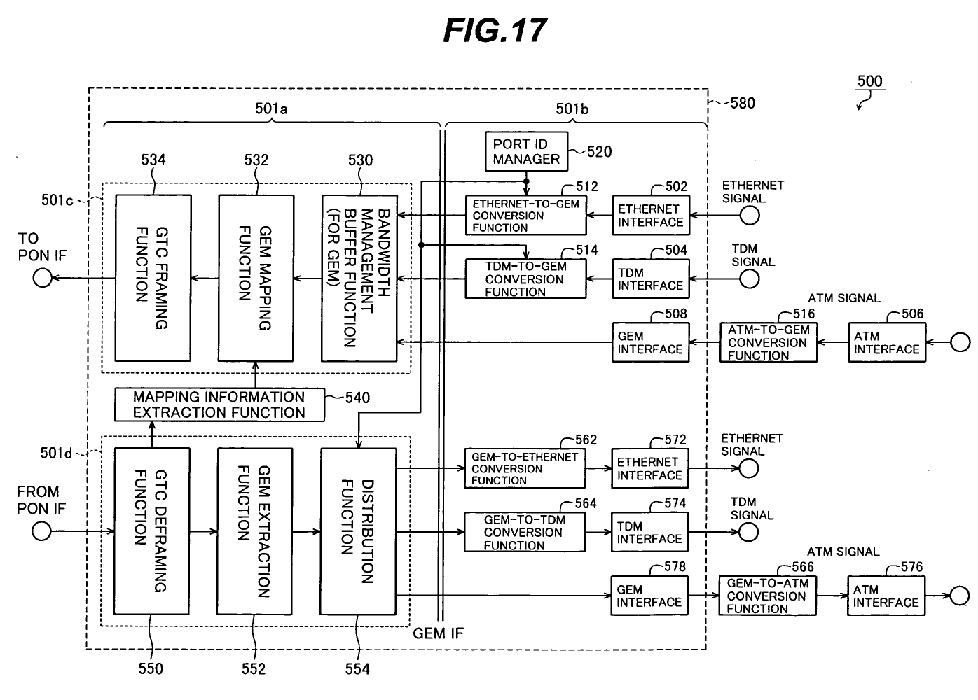

Referring to FIG. 17, for example, the chip set 580 may include a core section 501a identical to the core section 101a in FIG. 13, and a service section 501b that includes a pair of GEM interfaces 508, 578 instead of the ATM interfaces 106, 176, ATM-to-GEM conversion function 116, and the GEM-to-ATM conversion function 166 of the service section 101b in FIG. 13. This chip set 580 may be used either in an ONU that supports ATM communication or an ONU that does not support ATM communication.

The signal processing apparatus 500 in FIG. 17 is used in an ONU that supports ATM communication, so it includes an ATM-to-GEM conversion function 516, a GEM-to-ATM conversion function 566, and a pair of ATM interfaces 506, 576 in addition to the chip set 580. The ATM-to-GEM conversion function 516 converts ATM signals to GEM frames and inputs them to GEM interface 508 in the chip set 580. This GEM interface 508 sends the GEM frames directly to the bandwidth management buffer function 530 in the GTC output section 501c. Similarly, GEM frames including ATM cells are routed from the distribution function 554 in the GTC input section 501d through GEM interface 578 to the GEM-to-ATM conversion function 566, which converts them to ATM signals and sends the ATM signals to ATM interface 576.

If the signal processing apparatus 500 does not need to support ATM communication, then the GEM interfaces 508, 578 can be used for other purposes. For example, the ATM-to-GEM conversion function and GTM-to-ATM conversion function can be replaced with a TDM-to-GEM conversion function and a GEM-to-TDM conversion function. The TDM interfaces 504, 574, the TDM-to-GEM conversion function 514, and the GEM-to-TDM conversion function 564 in the chip set 580 can then be used to process TDM signals having one bandwidth, and the GEM interfaces, the external TDM-to-GEM conversion function, and the external GEM-to-TDM conversion function can be used to process TDM signals having a different bandwidth.

Alternatively, if only Ethernet signals and one type of TDM signals need to be processed, the GEM interfaces 508, 578 in the chip set 580 can be left unused.

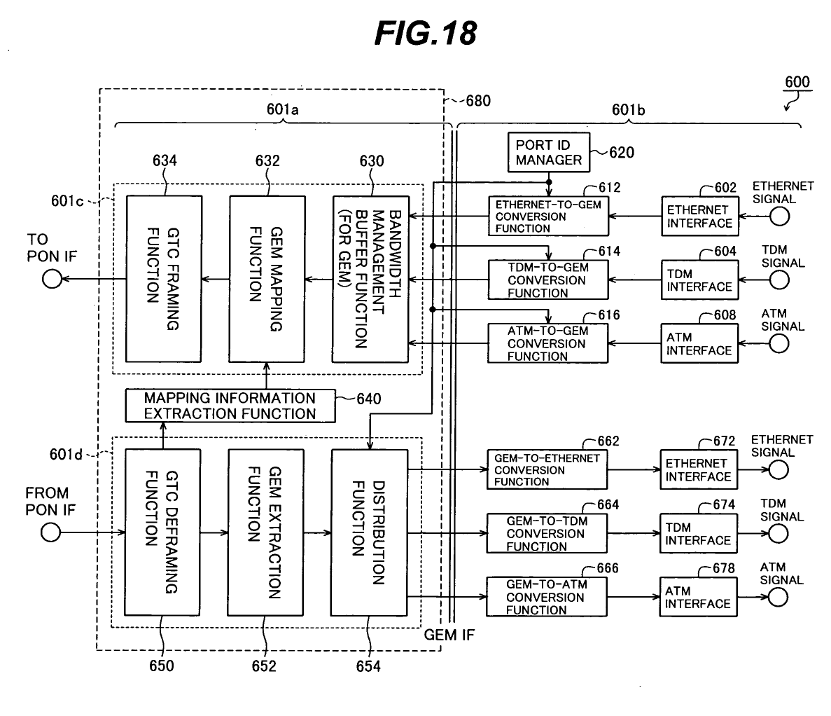

The invention can also be practiced as shown in FIG. 18, by implementing the core section 601a in the chip set 680, and implementing the entire service section 601b outside the chip set. FIG. 18 shows an example in which the chip set 680 is used in an ONU that supports ATM communication, so the service section 601b has the same structure as the service section 101b in FIG. 13. One advantage of this chip set 680 is that if the ONU only needs to process one type of signal, e.g., Ethernet signals, then only one pair of interfaces and conversion units, e.g. the Ethernet interfaces 602, 672, the Ethernet-to-GEM conversion function 612, and the GEM-to-Ethernet conversion function 662, have to be implemented in the service section 601b. Another advantage is that by providing the appropriate interface and conversion circuits, the chip set 680 can be used in a communication system that does not carry Ethernet, TDM, or ATM signals but carries some other type of signal instead, without the incurring the cost of unnecessary Ethernet, TDM, and ATM signal processing circuitry.

The present invention can accordingly provide a low-cost core chip set can then be used in all GPON systems, and can be supplemented with only the necessary additional chips in each system in which it is used.

In addition to these variations of the embodiment shown in FIGS. 13 to 16, those skilled in the art will recognize that further variations are possible within the scope of the invention, which is defined in the appended claims.

What is claimed is:

1. A signal processing apparatus used in a gigabit passive optical network (GPON) employing a GPON encapsulation mode (GEM) to encapsulate Ethernet signals and time-division multiplexed (TDM) signals in GPON transmission convergence (GTC) frames including respective payloads and overhead, the signal processing apparatus comprising:
an Ethernet-to-GEM conversion function for converting input Ethernet signals to GEM frames;
a TDM-to-GEM conversion function for converting input TDM signals to GEM frames;
a non-GEM-to-GEM conversion function for converting input non-GEM signals to GEM frames, the input non-GEM signals being signal other than Ethernet signals and TDM signals;
a GEM-to-Ethernet conversion function for converting GEM frames to output Ethernet signals;
a GEM-to-TDM conversion function for converting GEM frames to output TDM signals;
a GEM-to-non-GEM conversion function for converting GEM frames to output non-GEM signals;
a GTC input section for receiving input GTC frames, extracting GEM frames from the payloads of the input GTC frames, determining which one of an Ethernet signal, a TDM signal, and a non-GEM signal is included in each GEM frame, and sending GEM frames including Ethernet signals to the GEM-to-Ethernet conversion function, GEM frames including TDM signals to the GEM-to-TDM conversion function, and GEM frames including non-GEM signals to the GEM-to-non-GEM conversion function;
a mapping information management function for generating mapping information from the overhead of the input GTC frames received by the GTC input section; and
a GTC output section for mapping the GEM frames generated by the Ethernet-to-GEM conversion function, the TDM-to-GEM conversion function, and the non-GEM-to-GEM conversion function onto output time slots, based on mapping information generated by the mapping information management function, adding overhead to the GEM frames to create output GTC frames, and outputting the output GTC frames in the time slots.

2. The signal processing apparatus of claim 1, wherein:
the GTC input section includes a GTC deframing function, a GEM extraction function, and a distribution function;
the GTC deframing function disassembles each input GTC frame into its overhead and payload, sends the overhead to the mapping information management function, and sends the payload to the GEM extraction function;
the GEM extraction function extracts one or more GEM frames or fragments thereof from the payload and sends the GEM frames or fragments to the distribution function;
the distribution function determines which one of an Ethernet signal, a TDM signal, and a non-GEM signal is included in each GEM frame, and sends a GEM frame including an Ethernet signal to the GEM-to-Ethernet conversion function, a GEM frame including a TDM signal to the GEM-to-TDM conversion function, and a GEM frame including a non-GEM signal to the GEM-to-non-GEM conversion function;
the GTC output section includes a bandwidth management buffer function, a GEM mapping function, and a GTC framing function;
the bandwidth management buffer function temporarily stores the GEM frames received from the Ethernet-to-GEM conversion function, the TDM-to-GEM conversion function, and the non-GEM-to-GEM conversion function in a buffer, and sends the GEM frames from the buffer to the GEM mapping function responsive to commands from the GEM mapping function;
the GEM mapping function assigns the GEM frames received from the bandwidth management buffer function to the output time slots according to the mapping information received from the mapping information management function; and
the GTC framing function generates a frame header, generates a GTC frame with overhead and a payload by placing the frame header in the overhead and placing one or more GEM frames or fragments of GEM frames assigned to a particular output time slot in the payload, and outputs the output GTC frame.

3. The signal processing apparatus of claim 1, wherein the GTC input section, the GTC output section, the mapping information management function, the Ethernet-to-GEM conversion function, the GEM-to-Ethernet conversion function, the TDM-to-GEM conversion function, and the GEM-to-TDM conversion function are implemented in a chip set, and the non-GEM-to-GEM conversion function and the GEM-to-non-GEM conversion function are implemented outside the chip set.

4. The signal processing apparatus of claim 1, wherein the GTC input section, the GTC output section, and the mapping information management function are implemented in a chip set and the Ethernet-to-GEM conversion function, the GEM-to-Ethernet conversion function, the TDM-to-GEM conversion function, the GEM-to-TDM conversion function, the non-GEM-to-GEM conversion function, and the GEM-to-non-GEM conversion function are implemented outside the chip set.

5. The signal processing apparatus of claim 1, wherein the non-GEM signals are asynchronous transfer mode (ATM) signals.

6. The signal processing apparatus of claim 5, wherein the non-GEM-to-GEM conversion function converts ATM signals to GEM frames having respective payload length indicators, respective port identifiers, respective payload type indicators, respective header error control sections, and respective payloads by placing entire ATM cells, including ATM header information, in the payloads of the GEM frames.

7. The signal processing apparatus of claim 1, wherein the non-GEM signals are time-division multiplexed signals having a different bandwidth from the TDM signals input to the TDM-to-GEM conversion function and the TDM signals output from the GEM-to-TDM conversion function.

8. A signal processing method for processing signals in a gigabit passive optical network (GPON) that uses a GPON encapsulation mode (GEM) to encapsulate Ethernet signals and TDM signals in the payloads of GPON transmission convergence (GTC) frames, the method comprising:
converting input Ethernet signals, input TDM signals, and input non-GEM signals to respective GEM frames, the input non-GEM signals being signals other than Ethernet signals and TDM signals;
mapping the GEM frames onto time slots;
combining the GEM frames with overhead to generate output GTC frames; and
transmitting the output GTC frames in the time slots.

9. The signal processing method of claim 8, wherein all user signals carried in the payloads of the GTC frames are encapsulated in the GEM frames.

10. The signal processing method of claim 8, wherein each GEM frame includes a port identifier, a payload type indicator, header error control information, and a GEM payload.

11. The signal processing method of claim 10, wherein each GEM frame that includes a non-GEM signal encapsulates one or more complete asynchronous transfer mode (ATM) cells, including ATM header information, in its GEM payload.

12. The signal processing method of claim 10, wherein each GEM frame that includes a non-GEM signal encapsulates a time-division multiplexed signal having a different bandwidth from said TDM signal in its GEM payload.

13. A signal processing method for processing signals in a gigabit passive optical network that uses a GPON encapsulation mode (GEM) to encapsulate Ethernet signals and TDM signals in GTC frames, the method comprising:
receiving input GTC frames;
disassembling the input GTC frames into respective overhead and payloads;
extracting GEM frames from the payloads;
determining which one of an Ethernet signal, a TDM signal, and a non-GEM signal is included in each GEM frame, the non-GEM signals being signals other than Ethernet signals and TDM signals;
converting each GEM frame including an Ethernet signal to an output Ethernet signal;
converting each GEM frame including a TDM signal to an output TDM signal; and
converting each GEM frame including a non-GEM signal to an output non-GEM signal.

14. A GTC frame used in a gigabit passive optical network, comprising:
an overhead section including information necessary for control, maintenance, and operation; and
a payload section for transporting user signals, the payload section including one or more GEM frames or fragments thereof; wherein
all user signals carried in the payload section, including non-GEM signals as well as Ethernet signals and TDM signals, are encapsulated in the GEM frames.

15. The GTC frame of claim 12, wherein the non-GEM signals are ATM signals.

16. The GTC frame of claim 13, wherein each GEM frame encapsulating said ATM signals includes one or more entire ATM cells, in ATM header information.

17. The GTC frame of claim 12, wherein the non-GEM signals are time-division multiplexed signals having a different bandwidth from the TDM signals.
